(19) United States
(12) Patent Application Publication
(10) Pub. No.: US 2013/0300546 A1
(43) Pub. Date: Nov. 14, 2013

(54) REMOTE CONTROL METHOD AND APPARATUS FOR TERMINALS

(71) Applicant: Samsung Electronics Co., Ltd., (US)

(72) Inventors: Hyunsoo KIM, Hwaseong-si (KR); Jehan YOON, Seongnam-si (KR)

(73) Assignee: Samsung Electronics Co., Ltd., Suwon-si (KR)

(21) Appl. No.: 13/863,031

(22) Filed: Apr. 15, 2013

(30) Foreign Application Priority Data
Apr. 13, 2012 (KR) 10-2012-0038428

(51) Int. Cl. G08C 19/00

(52) U.S. Cl. CPC G08C 19/00
USPC 340/12.22

(57) ABSTRACT

A remote control method may include: sending a control privilege request message to a control privilege manager; receiving, by an agent, a control privilege response message corresponding to the control privilege request message; and transitioning from a passive mode during which the agent is remotely controlled by an external device to an active mode during which the agent remotely controls an external device.

### CROSS-REFERENCE TO RELATED APPLICATION

This application claims the priority from the Korean Patent Application No. 10-2012-0038428, filed on Apr. 13, 2012, in the Korean Intellectual Property Office, the entire disclosure of which is hereby incorporated by reference.

### BACKGROUND

1. Field

Apparatuses and methods consistent with exemplary embodiments relate to remote control of terminals and, more particularly, to selecting one of multiple terminals as a terminal having a control privilege and enabling the terminal having a control privilege to remotely control other terminals.

2. Description of the Related Art

In recent years, speech recognition technology has rapidly advanced. In addition to speech-to-text conversion or word recognition, speech recognition software may comprehend context in a fashion similar to a human. Speech recognition has been used in various terminals such as, for example, smartphones, televisions (e.g., smart TVs) and tablet computers. A terminal may perform various functions related to, for example, photographing, Internet access, music playback and navigation in response to user input, such as, for example, verbal commands. A single user may conveniently operate multiple terminals using speech recognition technology that recognizes verbal commands.

### SUMMARY

However, confusion may occur when there are multiple terminals that can respond to verbal input of the user. For example, in response to verbal input of “What's the weather like today?”, both a smartphone and a smart TV may provide weather information to the user. The weather information provided by the smartphone may be different from that provided by the smart TV. In most cases, there is no need for multiple terminals to simultaneously respond to the same user input. Hence, there is a need for methods and apparatuses allowing a user to control multiple terminals.

A method includes sending a control privilege request message to a control privilege manager; receiving, by an agent, a control privilege response message corresponding to the control privilege request message; and transitioning from a passive mode during which the agent is remotely controlled by an first external device to an active mode during which the agent remotely controls an second external device. The first external device and the second device may be the same device.

A method includes receiving request messages for a control privilege enabling remote control of an external device from at least two agents included in a terminal and in the external device; determining to grant a control privilege to at least one of the at least two agents based on reference information contained in the request messages; and sending a response message containing a control privilege grant indication to the agent determined to receive the control privilege.

A terminal includes a wireless communicator configured to communicate with an external device; and a controller configured to control the wireless communicator, wherein the controller is configured to control the wireless communicator to send a control privilege request message and to receive a control privilege response message corresponding to the control privilege request message, and transitions, from a passive mode during which the controller is remotely controlled by an external device to an active mode during which the controller remotely controls the external device when a control privilege grant indication is present in the control privilege response message.

A terminal includes a wireless communicator configured to receive request messages for a control privilege for enabling remote control of other devices, from external devices; and a controller configured to control the wireless communicator, wherein the controller is configured to determine to grant a control privilege to one of the external devices based on reference information contained in the request messages, and controls the wireless communicator to send a response message containing a control privilege grant indication to the external device determined to receive the control privilege.

### BRIEF DESCRIPTION OF THE DRAWINGS

The above and/or other aspects will become more apparent by describing certain exemplary embodiments, with reference to the accompanying drawings, in which:

FIG. 1 is a block diagram of a terminal according to an exemplary embodiment;

FIG. 2 illustrates a network architecture for an agent service system according to an exemplary embodiment;

FIG. 3 illustrates another network architecture for an agent service system according to an exemplary embodiment;

FIGS. 4 and 5 are block diagrams of a server and a client of a centralized type according to an exemplary embodiment;

FIGS. 6 and 7 are block diagrams of a server and a client of a cloud type according to an exemplary embodiment;

FIG. 8 is a sequence diagram of a process for granting a control privilege according to an exemplary embodiment;

FIG. 9 is a flowchart of a process for determining an agent to be granted a control privilege according to an exemplary embodiment;

FIG. 10 is a sequence diagram for a process for transferring a control privilege according to an exemplary embodiment;

FIG. 11 is a sequence diagram for a process for re-requesting a control privilege according to an exemplary embodiment;

FIG. 12 is a sequence diagram for a detailed illustration of an agent service according to an exemplary embodiment;

FIG. 13 is a sequence diagram for another detailed illustration of an agent service according to an exemplary embodiment;

FIGS. 14A, 14B, and 14C are brief illustrations of agent services according to an exemplary embodiment;

FIGS. 15 and 16 are brief illustrations of agent services according to an exemplary embodiment;

FIG. 17 is a flowchart of a process for configuring a control privilege according to an exemplary embodiment; and

FIG. 18 illustrates an environment setting screen for the terminal according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

The meaning of specific terms or words used in the specification and the claims should not be limited to the literal or commonly employed sense, but should be construed in accordance with the inventive concept. In the drawings, some elements are exaggerated or only outlined in brief, and thus may be not drawn to scale. Exemplary embodiments are not limited by relative sizes of objects and intervals between objects in the drawings.

The phrase “control privilege” as used herein encompasses its plain and ordinary meaning including, but not limited to, a special right that is granted to a selected terminal or an electronic device so as to remotely control other terminals or electronic devices through, for example, wired or wireless communication. A user may grant a control privilege to a selected terminal. For example, when there are multiple terminals such as a tablet computer, a smartphone, a television (e.g., smart TV), and a navigation system that are associated with a user, the user may grant a control privilege to the smartphone. The control privilege may also be granted after an agreement between the terminals or the electronic devices. For example, a tablet computer and a smartphone may each compute signal-to-noise ratios (SNR) of a voice input from the user, and share the computed SNRs through, for example, wireless communication. If the SNR computed by the smartphone is higher than that computed by the tablet computer, the smartphone may be granted a control privilege and be authorized to control the tablet computer remotely.

The term “agent” as used herein encompasses its plain and ordinary meaning including, but not limited to, a component of an electronic device or a terminal for exercising the control privilege. When the agent of a terminal or an electronic device possesses a control privilege, the terminal electronic device may operates in an active mode so as to remotely control other terminals or electronic devices. When the agent of an electronic device or a terminal does not possess a control privilege, the electronic device or the terminal may operate in a passive mode so as to be remotely controlled by another terminal possessing a control privilege. The agent may be a software component or a hardware component of a terminal.

The remote control method and apparatus of the present disclosure may be applied to various terminals supporting communication. For example, the remote control method and apparatus of the present disclosure may be applied to communication and multimedia devices, such as a smartphone, tablet computer, laptop computer, desktop computer, television (e.g., smart TV), navigation system, and video phone. The remote control method and apparatus of the present disclosure may also be applied to convergence devices such as a refrigerator having a TV and/or a communication function and TV system.

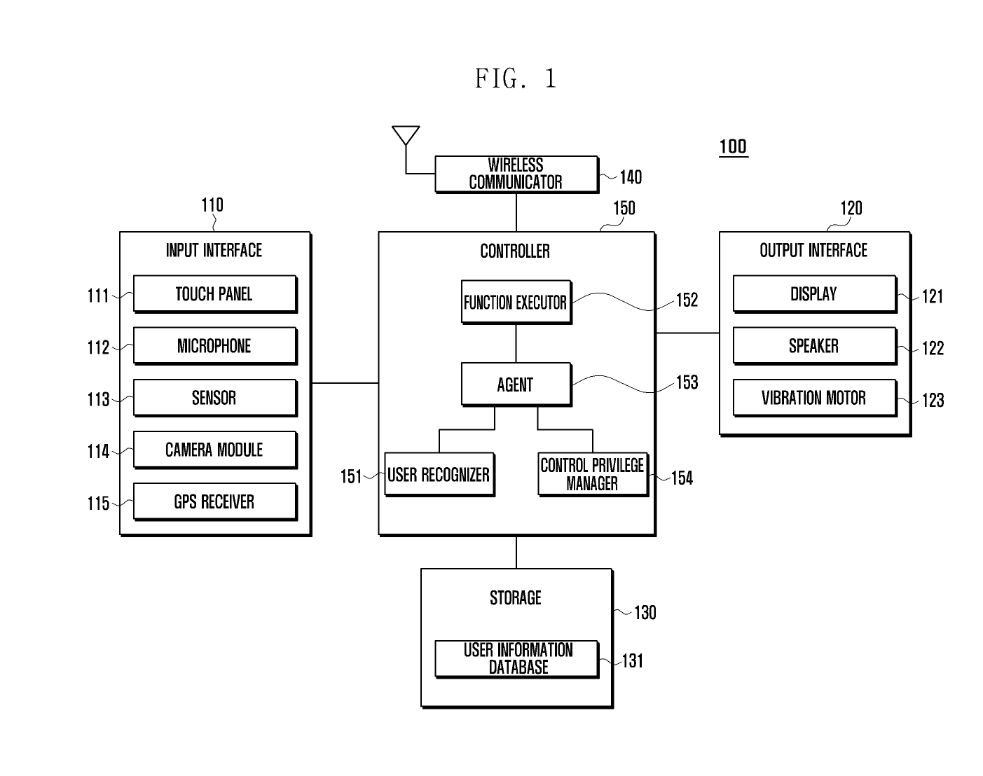

FIG. 1 is a block diagram of a terminal such as, for example, a smartphone according to an exemplary embodiment. Referring to FIG. 1, the terminal 100 may include an input interface 110, an output interface 120, a storage 130, a wireless communicator 140, and a controller 150. The terminal 100 having the above configuration may act as a client that requests another terminal to process data or act as a server that processes data according to a request from another terminal and exercises the control privilege to other terminals.

In an exemplary embodiment, the user interface interacting with the user may include the input interface 110 for receiving user input, and the output interface 120 for outputting audible, visual and/or haptic feedback to the user. The input interface 110 may include a touch panel 111, a microphone 112, a sensor 113, a camera module 114, and a GPS receiver 115. The output interface 120 may include a display 121, a speaker 122, and a vibration motor 123.

The touch panel 111 may be placed on the display 121. The touch panel 111 may generate touch data corresponding to a touch gesture made by the user and may send the touch data to the controller 150. The touch panel 111 may be implemented, for example, as an add-on type which may be placed on the display 121 or an on-cell or in-cell type which may be inserted in the display 121. The controller 150 may control other components such as the components discussed above based on touch data provided by the touch panel 111.

The microphone 112 may generate an electrical signal corresponding to an audio signal (e.g., a voice signal), convert the electrical signal into audio data through, for example, analog-to-digital conversion and send the audio data to the controller 150. The controller 150 may extract voice data from the audio data and control the other components based on the extracted voice data.

The sensor 113 may detect a change of state of the terminal 100, generate sensing data corresponding to the detected change of state, and send the sensing data to the controller 150. The sensor 113 may include at least one of various sensors such as an acceleration sensor, gyro sensor, illumination sensor, proximity sensor and pressure sensor. Upon receiving the sensing data, the controller 150 may control the other components based on the sensing data.

The camera module 114 may capture an image of a target object and outputs the image data to the controller 150. More specifically, the camera module 114 may include a lens for forming an image, an image sensor for converting an optical signal corresponding to the image into an electrical signal, and an image signal processor (ISP) for converting the electrical signal from the image sensor into image data and outputting the image data to the controller 150. The image signal processor may compress the image data. Upon reception of image data, the controller 150 may control the other components based on the image data.

The GPS receiver 115 may receive GPS signals from GPS satellites, calculates the location of the terminal 100, and send the location data to the controller 150. More specifically, the GPS receiver 115 may receive GPS signals containing transmission times from at least three GPS satellites. The GPS receiver 115 may calculate distances to the GPS satellites on the basis of time differences between reception times and transmission times of GPS signals. The GPS receiver 115 may determine the location (e.g., latitude and longitude) of the terminal 100 using the distance information and send the location information to the controller 150. Upon reception of location information, the controller 150 may control the other components according to the location information.

The display 121 may convert video data from the controller 180 into analog data and display the analog data. The display 121 may display various screens in the course of using the terminal 100, such as, for example, a lock screen, home screen, application handling screen, menu screen, keypad screen, message composition screen, and Internet access screen. The lock screen may be displayed immediately after the display 121 is turned on. When a touch event for unlocking is detected, the controller 150 may change the lock screen into the home screen or the application handling screen. The home screen may contain one or more application icons mapped to various applications. When an application icon is selected, the controller 150 may execute an application mapped to the selected application icon and display a corresponding application handling screen. The display 121 may include a flat display panel including liquid crystal display (LCD) devices, organic light emitting diodes (OLED), or active matrix organic light emitting diodes (AMOLED). The speaker 122 may convert audio data from the controller 150 into sound data and outputs corresponding sounds. The vibration motor 123 may provide haptic feedback. For example, when touch data is detected, the controller 150 may operate the vibration motor 123.

The storage 130 may store an operating system (OS) of the terminal 100, various programs and data. The storage 130 may include a program section and a data section.

The data section of the storage 130 may store the screens described above and setting values for normal operation of the terminal 100 (e.g., screen brightness, vibration upon touch detection, automatic screen orientation). The data section may temporarily store data copied from a message, webpage or document as clipboard data for copy and paste operations.

The data section may store a user information database 131. The user information database 131 may store various data generated by the terminal 100 (e.g., images captured by the camera module 114 and text messages), various data downloaded from external entities through the wireless communicator 140, user preference information, usage history information (e.g., Internet access times, recently viewed broadcasts, and information search records), and registration information. The registration information may be related to terminals allowed to receive the agent service, and may be managed by the user.

TABLE 1

| | | | Tablet | Laptop | Desktop | | | | Navigation | |
|---|---|---|---|---|---|---|---|---|---|---|
| | Phone 1 | Phone 2 | PC | PC | PC | TV | Fridge | Air Con | system | Printer |
| Network | Home | Home | Home | Home | Office | Home | Home | Home | Vehicle | Office |
| environment | Office | Office | Office | | | | | | | |
| | Vehicle | Vehicle | Vehicle | | | | | | | |
| User ID | A | B | A | A | A | A | A | A | A | A |
| | | | B | B | | B | B | B | B | |
| Terminal | A's | B's | A's | B's | A's | TV | Fridge | Air Con | Navigation | Printer |
| ID | phone 1 | phone 2 | tablet | laptop | desktop | | | | system | |
| | | | PC | PC | PC | | | | | |
| Input | Mic | Mic | Mic | Mic | Mic | Remote | Remote | Remote | Mic | X |
| interface | Camera | Camera | Camera | Camera | Camera | control | control | control | GPS | |
| | GUI | GUI | GUI | | | | | | Remote | |
| | GPS | GPS | Pen | | | | | | control | |
| | | | GPS | | | | | | | |
| Output | Speaker | Speaker | Speaker | Speaker | Speaker | Speaker | X | X | Speaker | X |
| interface | Display | Display | Display | Display | Display | Display | | | Display | |
| | Vibration | Vibration | Vibration | | | Vibration | | | | |
| Available | Broadcast | Call | Message | Speech | Speech | Broadcast | Broadcast | Air | Road | Print |
| function | (DMB) | Message | Search | recogni- | recogni- | (public) | (radio) | | guidance | |
| | Call | Search | | tion | tion | | | | | |
| | Message | | | Search | Search | | | | | |
| | Search | | | | | | | | | |
| Characteristics | WiFi | WiFi | WiFi | WiFi | WiFi | Wired | Wired | Wired | BT | WiFi |
| | 3G | 3G | | | | | | | | |
| | BT | BT | | | | | | | | |
| | NFC | NFC | | | | | | | | |
| Management | ◯ | ◯ | X | ◯ | ◯ | X | X | X | X | X |
| privilege | | | | | | | | | | |
| Control | ◯ | ◯ | ◯ | ◯ | ◯ | X | X | X | X | X |
| privilege | | | | | | | | | | |

As illustrated in Table 1, the registration information may include, for each registered terminal, information items such as “network environment”, “user ID”, “terminal ID”, “input interface”, “output interface”, “available function”, “available communication scheme”, “management privilege”, and “control privilege”. The network environment indicates a network environment to which a registered terminal may belong. For example, as Smartphone 1 (phone 1), Smartphone 2 (phone 2) and Tablet PC are portable devices, they may belong to a home network, an office network, or a vehicle network. As Navigation system is typically installed in a car, it may belong only to a vehicle network.

The network environment may be configured by the user. For example, the terminal 100 may display a network setting screen, and the user may configure a network environment for each registered terminal through the network setting screen and store the network environment information together with information on the registered terminal.

The network environment information may be automatically stored when a registration procedure is performed between terminals. For example, Smartphone 1 may find a different terminal, such as Tablet PC in the vicinity of the Smartphone 1 using short-range communication such as, for example, Bluetooth. Smartphone 1 may display a request message containing Tablet PC ID (e.g., device name). When the user accepts the request, Smartphone 1 sends a registration request message to Tablet PC. The registration request message may contain registration information of Smartphone 1 such as, for example, network environment, user ID, terminal ID, input interface, output interface, available function, capability such as communication scheme and battery power, management privilege and control privilege. Upon reception of the registration request message, Tablet PC may send a registration response message to Smartphone 1. The registration response message may contain registration information of Tablet PC.

User ID indicates a user who can use a particular terminal. For example, User ID may include a user name, phone number, email account, social networking service (SNS) account, voice feature information (e.g., tone, frequency, decibel, etc.), image data such as a face image, and handwriting information. Terminal ID characterizes a particular terminal, and may include terminal name, product name, model name, phone number, SSID (service set identifier), manufacturer information, and the like.

The registration information may further include an information item such as portability or may not include all the above information items.

The program section of the storage 130 may store an operating system (OS) for booting the terminal 100 and managing the above components, and various applications. For example, the program section may store a web browser for Internet access, an MP3 player for audio file playback, a camera application for capturing, displaying and storing an image of a target object, a user recognition program, an artificial intelligence program, and the like.

The user recognition program may include a voice recognition procedure and a face recognition procedure. The voice recognition procedure may extract voice feature information (e.g., tone, frequency, decibel and the like) from voice data, and compare the extracted voice feature information with stored voice feature information to identify the user. The voice recognition procedure may also perform speech-to-text conversion. The face recognition procedure may recognize a user face using an image captured by the camera module 114. Specifically, the face recognition procedure may extract face information from image data, and compare the extracted face information with stored face information to identify the user. In addition to voice recognition and face recognition, user recognition may be achieved through iris recognition, vein recognition, or fingerprint recognition.

The artificial intelligence program may identify the user's intent from voice data or image data. For example, the artificial intelligence program may include a natural language processing engine to understand context from voice data, a gesture recognition engine to understand a user gesture from image data, an inference engine to infer user's intent on the basis of the understood context, and a dialog engine to converse with the user on the basis of the understood context.

The wireless communicator 140 may perform operations for calls, data communication and digital broadcast reception. The wireless communicator 140 may include a mobile communication module (e.g., mobile communication module supporting 3G, 3.5G or 4G mobile communication), a local area communication module (e.g., a ZigBee module, Bluetooth module and Wi-Fi module), and a digital broadcast receiving module (such as a DMB module).

The controller 150 may control the operation of the terminal 100, control signal exchange between internal components of the terminal 100, and perform data processing. The controller 150 may execute various applications stored in the program section of the storage 130.

The controller 150 may include a user recognizer 151, a function executor 152, an agent 153, and a control privilege manager 154.

The user recognizer 151 may permit only a person or entity known in advance to the terminal 100 to use the terminal 100. If the terminal 100 is usable by many persons or entities without restriction, the user recognizer 151 may be omitted from the controller 150. The user recognizer 151 may receive input information from a user (e.g., user ID, voice data and image data) through the input interface 110, and identifies the user on the basis of the input information. For example, the user recognizer 151 may extract voice feature information (e.g., tone, frequency, decibel and the like) from voice data, and compare the extracted voice feature information with stored voice feature information to identify the user. The user recognizer 151 may extract face information from image data, and compare the extracted face information with stored face information to identify the user. The user recognizer 151 may receive a user ID through the touch panel 111, and compare the received user ID with stored user IDs to identify the user. If the user is known to the terminal 100 (e.g., the extracted voice feature information matches stored voice feature information, the extracted face information matches stored face information, or the received user ID matches a pre-stored user ID), the controller 150 may respond to input information from the user. When the user is unknown to the terminal 100, the controller 150 may not respond to input information from the user.

The function executor 152 may perform various functions of the terminal 100. Functions executable by the function executor 152 may be widely varied according to terminal types. For example, the function executor 152 may perform functions related to watching TV, broadcast recording, music playback, Internet banking, travel guidance, phone calls, messaging and the like. To identify user's intent, the function executor 152 may utilize, for example, a natural language processing engine, a gesture recognition engine, an inference engine and a dialog engine.

The terminal 100 may have a control privilege to remotely control other terminals. The controller 150 may include the agent 153 and may exercise the control privilege using the agent. The agent 153 may control the function executor 152 to carry out a function indicated by input information from the user. For example, the agent 153 may receive voice data representing “Is there a good restaurant around here?” through the input interface 110, and forward the voice data to the function executor 152, which may recognize the context associated with the voice data and may perform an appropriate operation. The function executor 152 may receive current location information from the GPS receiver 115. The function executor 152 may search the user information database 131 for information on favorite foods of the user and check Internet search logs. From the search results, the function executor 152 may determine that pasta, such as spaghetti and noodles, is the favorite food of the user. The function executor 152 may execute a restaurant search application to collect information on restaurants serving pasta (e.g., location, menu and price) nearby (e.g., within 500 meters from the current location). The function executor 152 may present the collected information on restaurants to the user through the output interface 120. For example, the function executor 152 may control the display 121 to mark the restaurants on a map. The function executor 152 may control the speaker 122 to output sounds describing locations and menus of the restaurants.

The agent 153 may remotely control an external terminal when it possesses a control privilege. For example, if the agent 153 receives voice data representing “Please record a drama” through the input interface 110, the agent 153 may forward the voice data to the function executor 152. The function executor 152 may recognize the context of the voice data, infers a drama to record with reference to the user information database 131, and sends the inference result (e.g., CSI: Crime scene investigation) to the agent 153. The agent 153 may send a record request for CSI through the wireless communicator 140 to a smart TV.

The terminal 100 may determine which of multiple agents possesses a control privilege. The controller 150 may include the control privilege manager 154 for determining the agent that possesses the control privilege. The control privilege manager 154 may receive a control privilege request message from one or more agents. When input information such as touch data, voice data or image data is received from a user, the corresponding agent may send a control privilege request message to the control privilege manager 154. The control privilege request message may contain reference information, which may be used by the control privilege manager 154 to determine a terminal to possess a control privilege. The reference information may include information on terminal characteristics (e.g., battery power, communication scheme, input interface, TV broadcast reception, and available function list), information on terminal states (e.g., operating mode such as busy state, idle state or sleep state, remaining battery power, use of free-of-charge network (Wi-Fi), and environment settings such as blocking of Wi-Fi direct), user input information (e.g., touch data, voice data or image data) and SNR for voice data, indication of a requested function which indicates the function that the user has requested, and requesting user ID. If a requested function is not identified (e.g., because of failure to recognize the context of voice data), indication of the requested function may be omitted from the reference information. Other information may also be added to the reference information.

If a single agent has sent a control privilege request message, the control privilege manager 154 may send a response message granting control privilege to the agent which sent the control privilege request message. If the agent having sent the control privilege request message is the internal agent 153, the control privilege manager 154 may send a response message to the agent 153. If the agent having sent a control privilege request message is an external agent, the control privilege manager 154 may send a response message through the wireless communicator 140 to the external agent.

If multiple agents have sent a control privilege request message, the control privilege manager 154 may determine an agent to possess the control privilege on the basis of reference information received from the individual agents. For example, the control privilege manager 154 may grant control privilege to an agent whose input information is touch data (e.g., an agent of a smartphone having detected touch input). The control privilege manager 154 may select agents whose input information is voice data (e.g., a smartphone, tablet computer and smart TV having detected voice input) as candidates for the control privilege. The control privilege manager 154 may grant control privilege to an agent with a highest SNR (e.g., the agent of a smartphone nearest to the user) among the candidates. The agent possessing a control privilege may operate in an active mode. The agent possessing a control privilege may relinquish the control privilege after finishing the user requested function (e.g., drama recording) by sending a privilege relinquish message to the control privilege manager 154. A candidate not possessing a control privilege may operate in a passive mode, and may make a new privilege request when a control privilege is needed (e.g., detection of voice input). A candidate agent in a passive mode which has made a new privilege request may be referred to as being in a wait mode. The control privilege manager 154 may transfer the control privilege to the agent having sent a new privilege request. If a privilege relinquish message is received from an agent possessing the control privilege, the control privilege manager 154 may transfer the control privilege to a candidate agent in a wait mode.

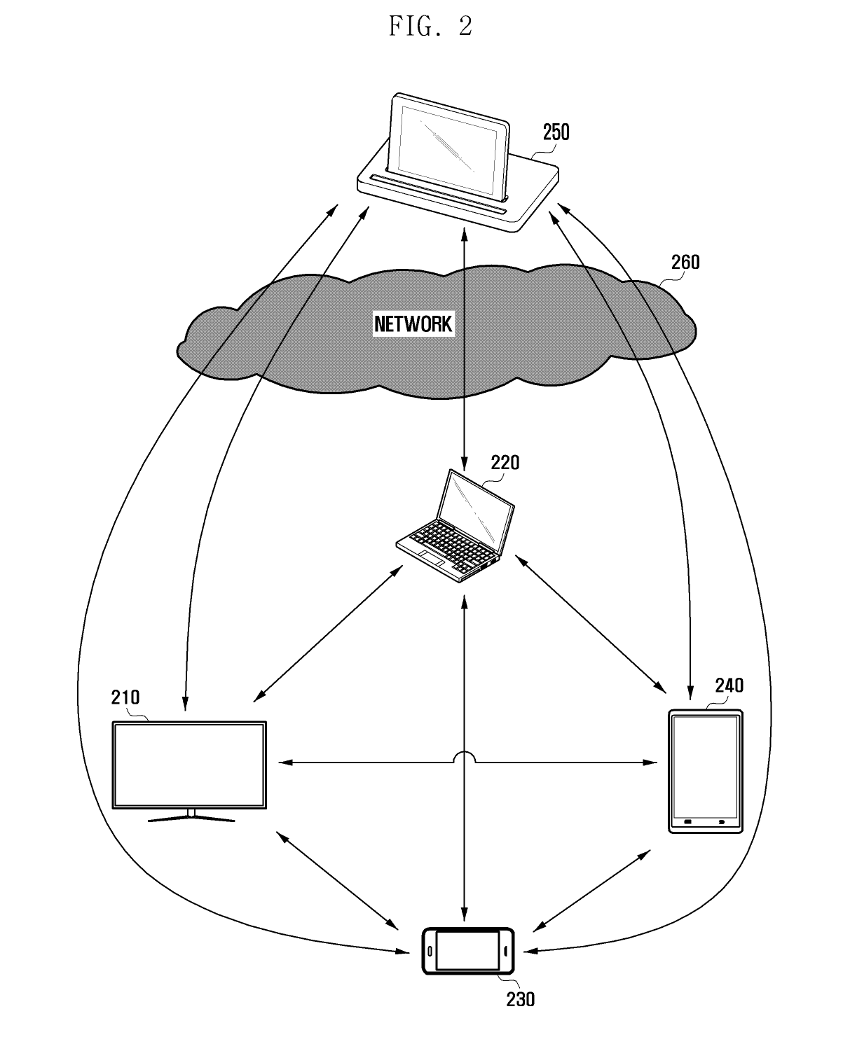

FIG. 2 illustrates a network architecture for an agent service system according to an exemplary embodiment. Referring to FIG. 2, the agent service system may include a plurality of terminals including a smart TV 210, laptop PC 220, smartphone 230, tablet PC 240 and server 250, and a network 260 connecting the same. The network 260 may include a local area network such as, for example, a Wi-Fi network and/or a mobile communication network (e.g., 3G, 3.5G or 5G).

Each of the terminals 210 to 250 may be a terminal described above with reference to FIG. 1. Each terminal may include an agent. In one example, the control privilege manager 154 determining a terminal to exercise a control privilege may be included in only one of the terminals 210 to 250. For example, only the server 250 may include the control privilege manager 154.

In another example, two or more terminals may include a control privilege manager 154. In such a case, the terminals having the control privilege manager 154 may negotiate with each other to determine a terminal to exercise a control privilege. For example, the terminals may each select a number from a given range (e.g., 1 to 200) and exchange the selected numbers through wireless communication. The terminal having selected the greatest number may be determined as a terminal to exercise the control privilege. A terminal may select the number, for example, according to its characteristics such as battery capacity, remaining battery power and portability. For example, a terminal may select a large number when the remaining battery power is sufficient. The negotiation may be performed when network configuration has changed. For example, when the user carrying a smartphone moves from the user's home where a home network is installed to a car where a navigation system is installed, the smartphone and the navigation system may perform such negotiation. Alternatively, the terminal to exercise control privilege may be determined according to user preference settings (e.g., the smartphone may be determined as a terminal to exercise the control privilege without negotiation based on user settings).

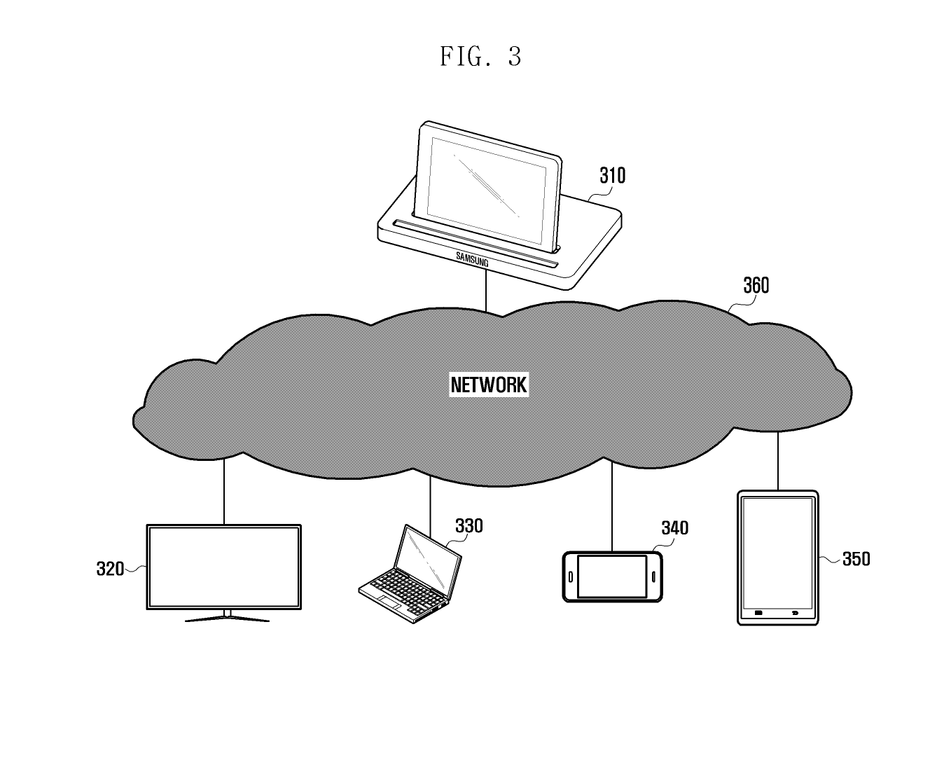

FIG. 3 illustrates another network architecture for an agent service system according to an exemplary embodiment. In FIG. 3, a terminal may operate as a server or a client. The agent service system may include a server 310, clients including a smart TV 320, laptop PC 330, smartphone 340 and tablet PC 350, and a network 360.

The agent service system illustrated in FIG. 3 may be of a centralized type or cloud type. In an agent service system of a centralized type, the clients 320 to 350 may interact with the user, and the server 310 may remotely control the clients 320 to 350 and perform data processing. For example, the server 310 may receive voice data “Please record a drama” from the smartphone 340, identify the context of the voice data and infer a drama to record with reference to the user information database (installed in the server 310), and send a drama record request to the smart TV 320.

In an agent service system of a cloud type, the clients 320 to 350 interact with the user and may exercise a control privilege according to determination of the server 310. The server 310 manages the control privilege and may perform data processing such as natural language processing, gesture recognition, inference, and information retrieval.

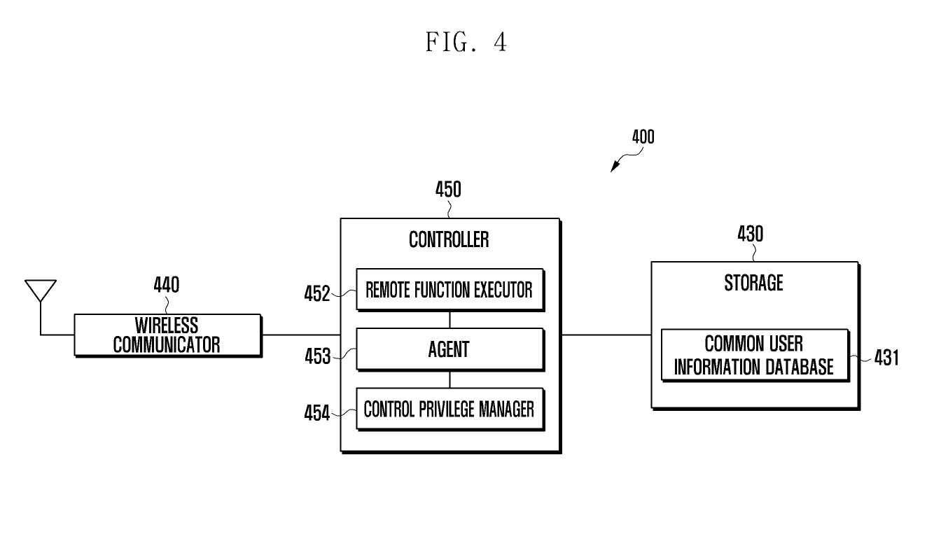

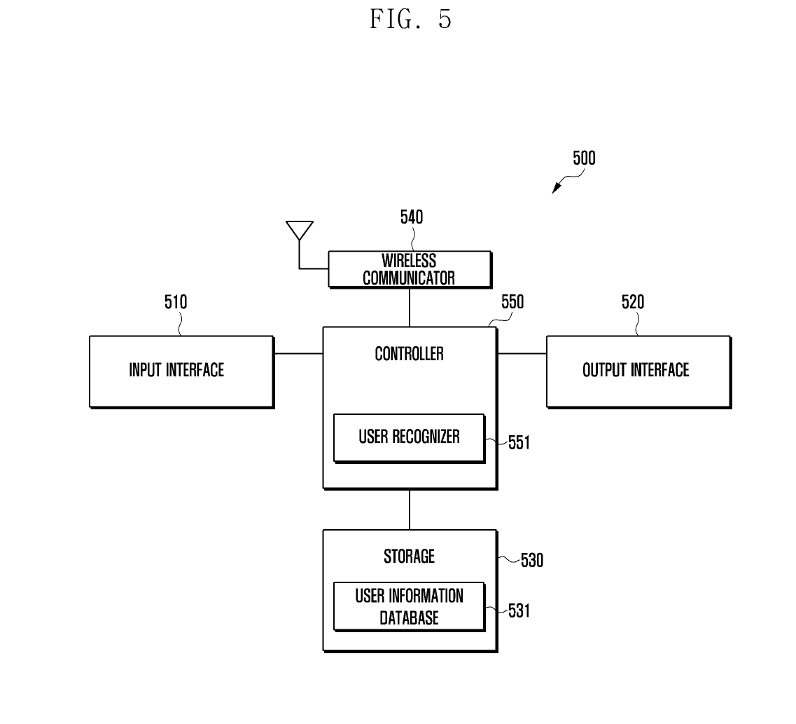

FIGS. 4 and 5 are block diagrams of a server 400 and a client 500 of a centralized type according to an exemplary embodiment.

Referring to FIG. 4, the server 400 of a centralized type may include a storage 430, a wireless communicator 440, and a controller 450.

The storage 430 may store an operating system of the server 400, various programs, and various data. In particular, the storage 430 may store a common user information database 431, which may contain information regarding user preferences, histories of executed functions, and client characteristics. The storage 430 may store an artificial intelligence program used to identify user intent from voice or image data.

The wireless communicator 440 may exchange data with a client. The wireless communicator 440 may include a mobile communication module and a local area communication module to exchange data with the client.

The controller 450 may control the operation of the server 400, control signal exchange between internal components thereof, and perform data processing. The controller 450 may execute various programs stored in the program section of the storage 430.

The controller 450 may include a remote function executor 452, an agent 453, and a control privilege manager 454. The remote function executor 452 may process user input information received through the wireless communicator 440 from a client. In particular, to identify user intent, the remote function executor 452 may utilize a natural language processing engine, a gesture recognition engine, an inference engine and a dialog engine. The agent 453 may exercise a control privilege over clients. Functions of the agent are described in detail with reference to FIGS. 1 to 3. The control privilege manager 454 may determine an agent to possess a control privilege.

Referring to FIG. 5, the client 500 of a centralized type may include an input interface 510, an output interface 520, a storage 530, a wireless communicator 540 and a controller 550. The controller 550 controls the operation of the above components, and may include a user recognizer 551. The components 510 to 550 and 551 are described in connection with FIGS. 1 to 3.

As described above, the server 400 of a centralized type may remotely control clients and perform data processing, and the client 500 may interact with the user. Although assigned functions are different, the server 400 and the client 500 may have the same configuration as a terminal shown in FIG. 1.

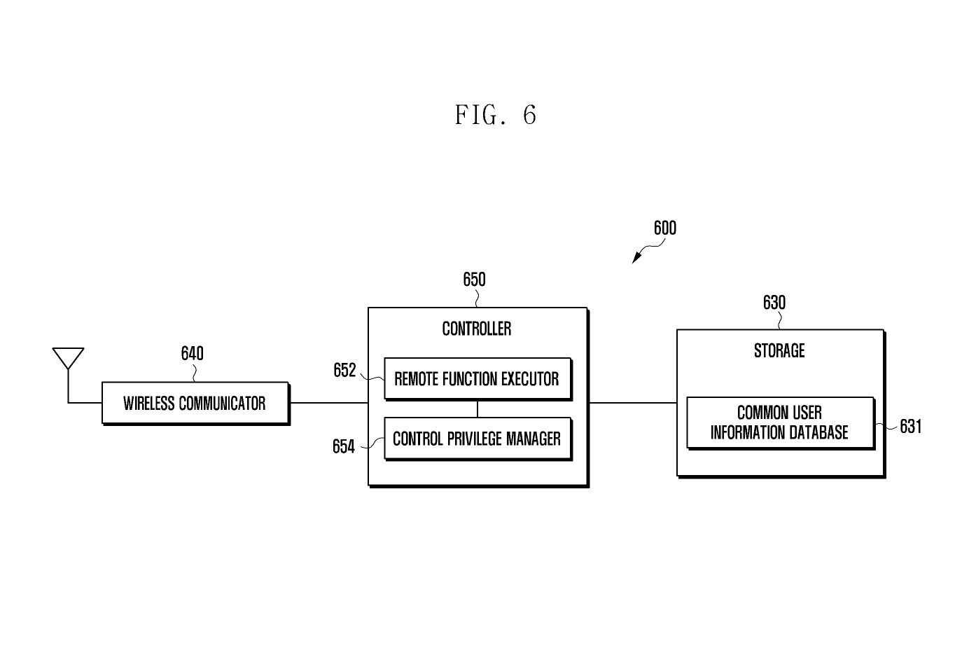

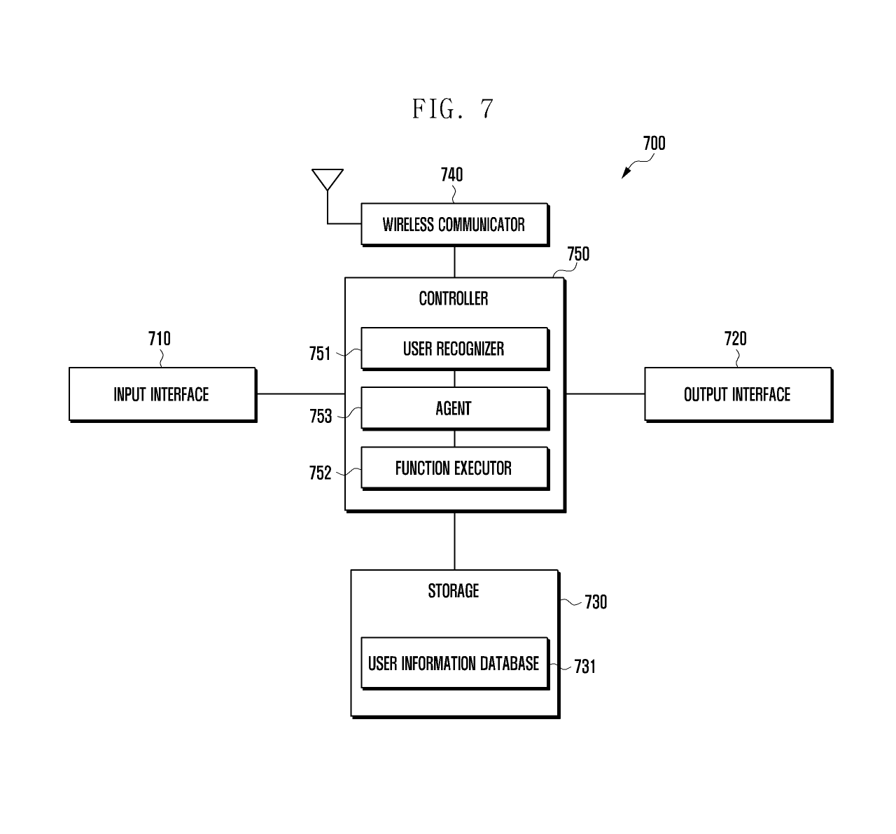

FIGS. 6 and 7 are block diagrams of a server 600 and a client 700 of a cloud type according to an exemplary embodiment. Referring to FIG. 6, the server 600 of a cloud type may include a storage 630, a wireless communicator 640, and a controller 650. The storage 630 may store a common user information database 631. The wireless communicator 640 exchanges data with a client. The controller 650 may control the operation of the server 600, and may include a remote function executor 652 and a control privilege manager 654. The components shown in FIG. 6 are described in detail with reference to FIGS. 1 to 5. Referring to FIG. 7, the client 700 of a cloud type may include an input interface 710, an output interface 720, a storage 730, a wireless communicator 740 and a controller 750. The controller 550 may control the operation of the above components, and may include a user recognizer 751, a function executor 752 and an agent 753. The above components shown in FIG. 7 are described in connection with FIGS. 1 to 5. As described above, the server 600 of a cloud type may manage the control privilege, and the client 700 may interact with the user. Although assigned functions are different, the server 600 and the client 700 may have the same configuration as a terminal shown in FIG. 1.

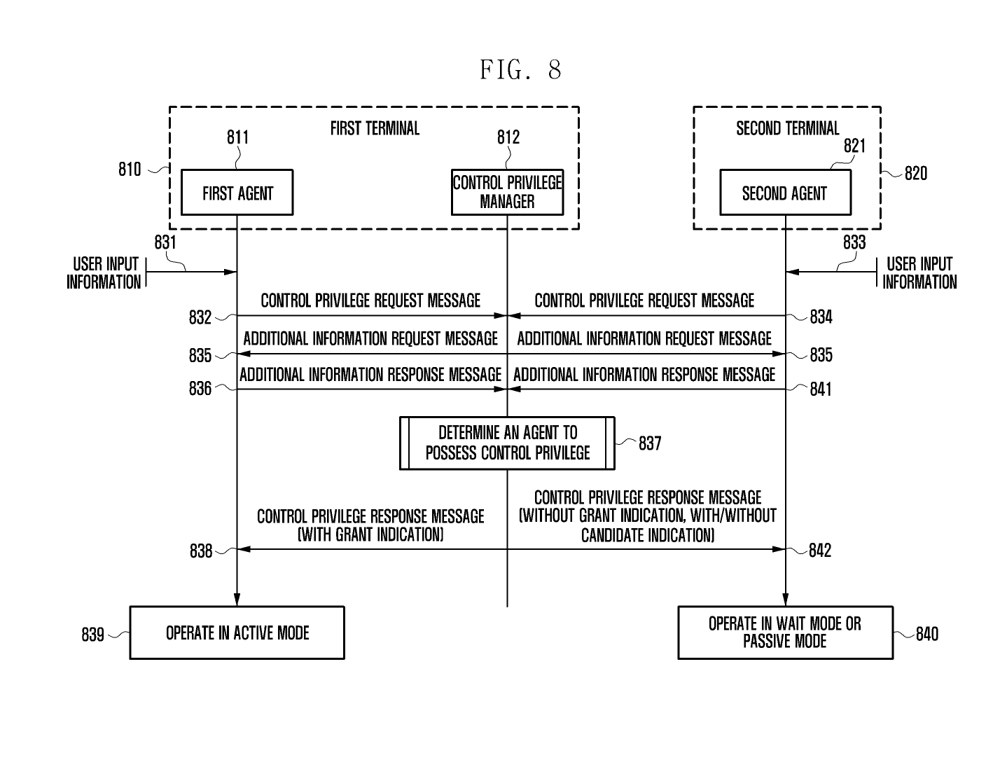

FIG. 8 is a sequence diagram of a process for granting control privilege according to an exemplary embodiment. Referring to FIG. 8, the first agent 811 of the first terminal 810 may receive voice data as user input information through the input interface (operation 831). Upon reception of the voice data, the first agent 811 may send a control privilege request message to the control privilege manager 812 of the first terminal 810 (operation 832). The control privilege manager 812 may be included in a third terminal other than the first terminal 810. FIG. 8 illustrates the case in which the first terminal 810 is already aware that the third terminal possesses the control privilege through a registration procedure as discussed above. If the first terminal 810 and a third terminal both possess a control privilege and which terminal to exercise the control privilege has yet to be determined, the first terminal 810 may exercise the control privilege after a negotiation procedure as described above. Operation 832 is performed after the user is known to the first terminal 810. User recognition is described above with reference to FIG. 1. As described above, the control privilege request message may include user input information, requested function information and user ID.

The second agent 821 of the second terminal 820 may receive voice data as user input information through the input interface (operation 833). Upon reception of the voice data, the second agent 821 may send a control privilege request message to the control privilege manager 812 (operation 832).

The control privilege manager 812 may send an additional information request message (e.g., for characteristic and state information) to the first agent 811 and to the second agent 821 (operation 835). The first agent 811 and the second agent 821 may each send an additional information response message containing requested information to the control privilege manager 812 (operations 836, 841). The first agent 811 and the second agent 821 may be distinguished by terminal and by user. For example, if the first terminal 810 and the second terminal 820 are used by the same user, the agents of the two terminals may be the same but may be distinguished by terminal. When the first terminal 810 and the second terminal 820 are used by different users, the agents of the two terminals are different may operate independently.

Operations 835, 836, and 841 may be omitted. For example, when the first terminal 810 and the second terminal 820 each send a control privilege request message containing characteristic and state information at operations 832 and 834, the control privilege manager 812 need not send an additional information request message.

The control privilege manager 812 may determine an agent to possess a control privilege on the basis of information received from the first agent 811 and the second agent 821 (operation 837). More specifically, when user IDs received from the first agent 811 and the second agent 821 are different, the control privilege manager 812 may grant a control privilege to both the first agent 811 and the second agent 821. For example, if a user ID received from the first agent 811 (e.g., daughter's ID) is different from a user ID received from the second agent 821 (e.g., mother's ID), the control privilege manager 812 may grant a control privilege to both the mother's terminal (e.g., smartphone) and the daughter's terminal (e.g., smartphone) so that the two terminals may remotely control other terminals. If user IDs received from the first agent 811 and the second agent 821 are the same, the control privilege manager 812 may determine an agent to possess a control privilege on the basis of the received information. For example, the control privilege manager 812 may grant a control privilege to an agent whose input information is touch data. The control privilege manager 812 may grant a control privilege to an agent with a highest SNR.

After determining an agent to possess a control privilege, the control privilege manager 812 may send a control privilege response message to the first agent 811 and the second agent 821 (operation 838). The control privilege response message may contain an indicator for granting a control privilege (e.g., ‘1’ for granting a control privilege and ‘0’ for not granting a control privilege). The agent having received a control privilege response message with a control privilege grant indication (e.g., first agent 811) may operate in the active mode (operation 839). The control privilege response message may also contain a candidate indication (e.g., ‘1’ for a candidate and ‘0’ for not a candidate). The agent having received a control privilege response message without a control privilege grant indication (e.g., the second agent 811) may operate in the passive mode or wait mode according to the candidate indication (operation 840).

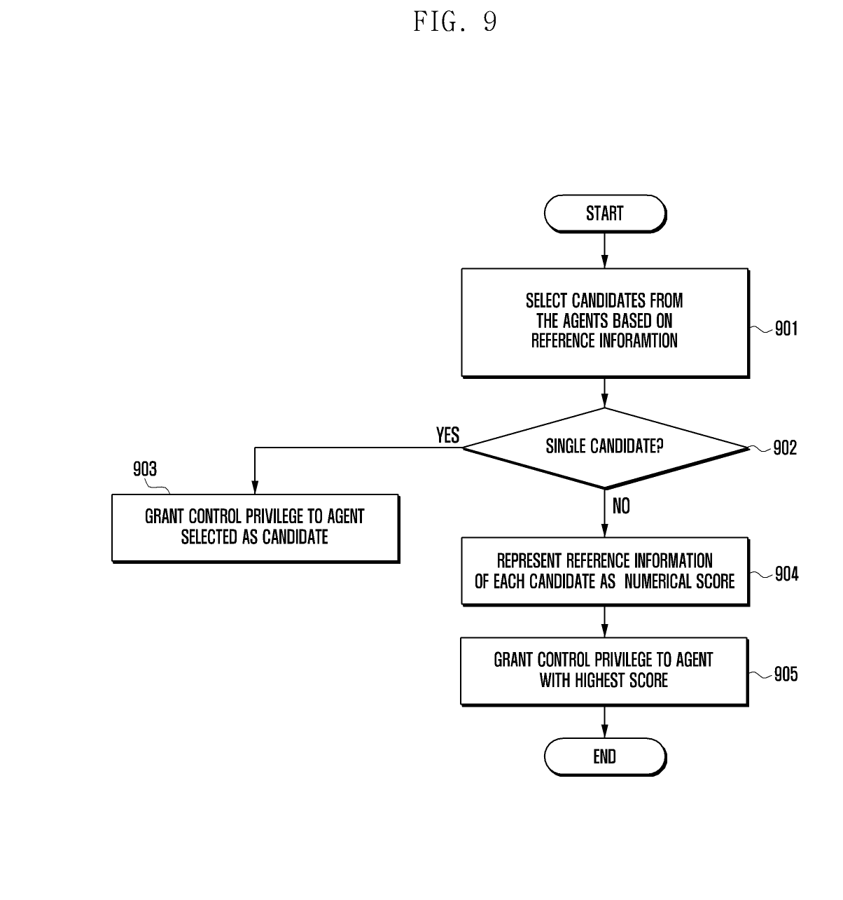

FIG. 9 is a flowchart of a process for determining an agent to possess a control privilege according to an exemplary embodiment. Referring to FIGS. 1 and 9, the control privilege manager 154 may receive a control privilege request message from one or more agents. If a control privilege request message is received from a single agent (either internal or external), the control privilege manager 154 may grant a control privilege to the agent. If control privilege request messages are received from two or more agents within a preset time (e.g., 1 second), the control privilege manager 154 may perform the following operations.

The control privilege manager 154 may select candidates from the agents having sent the control privilege request messages on the basis of received reference information including terminal characteristic and state information, user input information and requested function information described above (operation 901). For example, the control privilege manager 154 may select an agent whose input information is touch data as a candidate. If input information is voice data, the control privilege manager 154 may select an agent that has a corresponding input interface (e.g., microphone), such as a smartphone, tablet computer, laptop computer or smart TV, as a candidate. The control privilege manager 154 may also consider SNRs for candidate selection. The control privilege manager 154 may select an agent with an SNR higher than or equal to a threshold SNR of, for example, 60 dB as a candidate (e.g., a smartphone or tablet computer). The control privilege manager 154 may consider touch data first for candidate selection. For example, the control privilege manager 154 may select an agent of a terminal with touch data as a sole candidate.

The control privilege manager 154 may check whether the number of candidates is one (operation 902). If the number of candidates is one, the control privilege manager 154 may grant a control privilege to the agent selected as a candidate (operation 903).

When the number of candidates is more than one, the control privilege manager 154 may represent reference information of each candidate as a score (operation 904). For example, state information may be represented as a score as illustrated in Table 2 below.

TABLE 2

| | | | Currently connected | |
|---|---|---|---|---|
| Remaining battery | | | communication | |
| power | SNR | Operating mode | network | Score |
| Below 10% | — | Busy state | — | −1 |
| | | | | (excluded) |
| Below 30% | Below 60 dB | — | Paid communication | 10 |
| | | | network | |
| Below 50% | — | Idle state | — | 20 |
| Below 70% | Below 80 dB | — | — | 30 |
| Below 90% | — | Sleep state | Free-of-charge | 40 |
| | | | communication | |
| | | | network | |
| Higher than or | Higher than or | — | — | 50 |
| equal to 90% | equal to 80 dB | | | |
| ∞ | — | — | — | 100 |
| (use of external | | | | (topmost) |
| power source) | | | | |

At operation 904, the control privilege manager 154 may also assign weights to state information according to requested function information. For example, when a streaming service is requested, the control privilege manager 154 may add −50 to the score of an agent currently connected to a paid communication network (e.g., a 3G mobile communication network), and may add 100 to the score of an agent currently connected to a free-of-charge communication network (e.g., a Wi-Fi network). If the function requested by the user is unclear (owing to, e.g., the context of voice data is not recognized), assignment of weights may be skipped.

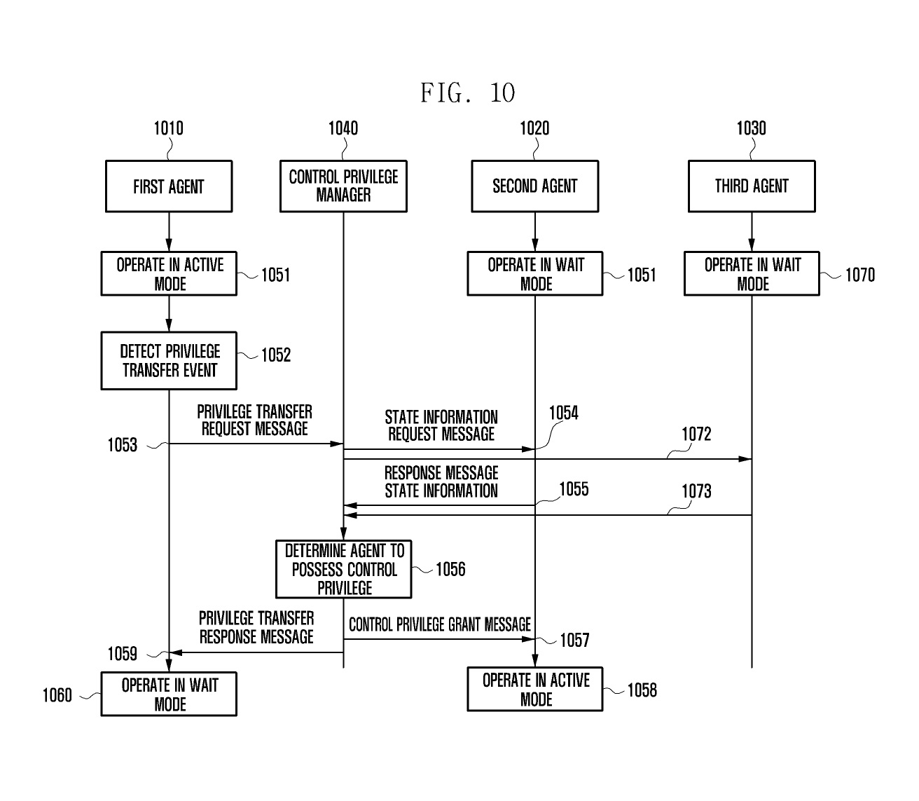

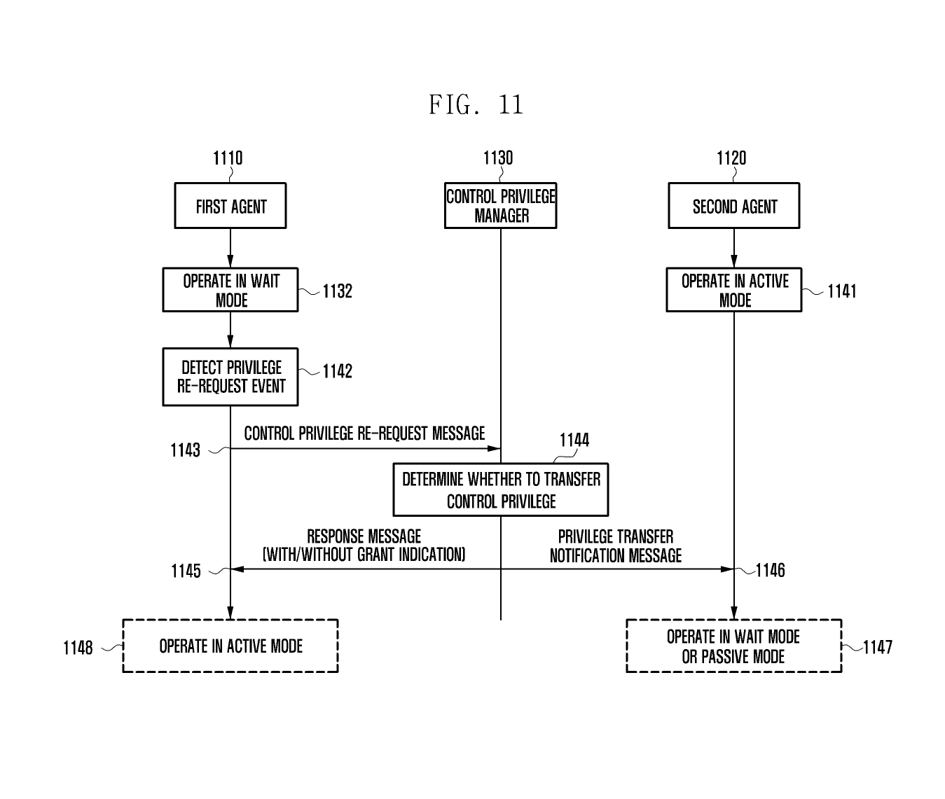

After scoring and weighting, the control privilege manager 154 may grant a control privilege to an agent with the highest score (operation 905). Here, as indicated in Table 2, an agent whose remaining battery power is below 10% or whose operating mode is a busy state (e.g., call in progress) may be excluded from possession of a control privilege even though it has the highest score. As indicated in Table 2, an agent using an external power source may obtain a control privilege even though it does not have the highest score. In some cases, the control privilege manager 154 may transfer the control privilege to another agent, in particular, one of candidates operating in the wait mode. Transfer of control privilege is illustrated with reference to FIG. 10. An agent having failed to obtain a control privilege (e.g., a candidate operating in the wait mode) may re-request the control privilege manager 154 for control privilege. Re-requesting of a control privilege is illustrated with reference to FIG. 11.

FIG. 10 is a sequence diagram for a process for transferring a control privilege according to an exemplary embodiment. In FIG. 10, a first agent 1010 may operate in the active mode after obtaining a control privilege from the control privilege manager 1040, and other agents including a second agent 1020 and a third agent 1030 may operate in the wait mode (operation 1051).

The first agent 1010 may detect a privilege transfer event (operation 1052). A privilege transfer event may be an event notifying low remaining battery power (e.g., below 20%) generated by the power management unit, or a call event (e.g., selection of a call button on the touchscreen or reception of an incoming call request signal through the wireless communicator). The first agent 1010 may send a privilege transfer request message to the control privilege manager 1040, for example, to reduce power consumption or handle a call (operation 1053). When system resources such as memory and CPU cycles are insufficient (e.g., because of multitasking), the first agent 1010 may also send a privilege transfer request message to the control privilege manager 1040.

Upon reception of the privilege transfer request message from the first agent 1010, the control privilege manager 1040 may select a different agent and grant a control privilege to the selected agent. For example, the control privilege manager 1040 may send a control privilege grant message to a candidate operating in the wait mode. If two or more candidates operate in the wait mode, the control privilege manager 1040 may perform the following described below operations.

The control privilege manager 1040 may send a state information request message (e.g., for remaining battery power, operating mode and connected communication network) to the candidates operating in the wait mode including the second agent 1020 and third agent 1030 (operation 1054). The control privilege manager 1040 may receive a state information response message containing requested information from the second agent 1020 and the third agent 1030 (operation 1055).

The control privilege manager 1040 may determine an agent to possess a control privilege among the candidates on the basis of received state information (operation 1056). For example, as described above with reference to FIG. 9, the control privilege manager 1040 may represent the received state information as a score and grant a control privilege to an agent with the highest score. The control privilege manager 1040 may send a control privilege grant message to the agent with the highest score, for example, the second agent 1020 (operation 1057). Upon reception of the control privilege grant message, the second agent 1020 may operate in the active mode (operation 1058). The control privilege manager 1040 may send a privilege transfer response message indicating completion of control privilege transfer to the first agent 1010 (operation 1059). Upon reception of the privilege transfer response message, the first agent 1010 may operate in the wait mode (operation 1060).

FIG. 11 is a sequence diagram for a process for re-requesting a control privilege according to an exemplary embodiment. In FIG. 11, a first agent 1110 may operate in the wait mode, and a second agent 1020 may operate in the active mode after obtaining a control privilege from the control privilege manager 1130 (operation 1141).

The first agent 1110 may detect a privilege re-request event (e.g., generation of user input information including touch data, voice data and image data) (operation 1142). The privilege re-request event may correspond to generation of touch data, voice data or image data, use of an external power source, end of a call, or connection to a free-of-charge network. For example, if power or system resources are sufficient, user input information may be detected, or the first agent 1110 is connected to a free-of-charge network, the first agent 1110 may send a control privilege re-request message to the control privilege manager 1130 (operation 1143).

The control privilege manager 1130 may receive a control privilege re-request message from the first agent 1110. The control privilege re-request message may be identical to the control privilege request message described above. For example, the control privilege re-request message may contain information on terminal characteristics, information on terminal states, and user input information. The control privilege manager 1130 may determine whether to transfer the control privilege (operation 1144). More specifically, the control privilege manager 1130 may analyze reference information of the first agent 1110 re-requesting a control privilege and the second agent 1120 possessing a control privilege. Based on the analysis result, the control privilege manager 1130 may determine to transfer the control privilege to the first agent 1110. For example, if user input information of the first agent 1110 indicates touch data (the user made a touch gesture on the touchscreen of the terminal corresponding to the first agent 1110), the control privilege may be determined to be transferred to the first agent. As another example, if the score of the first agent 1110 is higher than that of the second agent 1120 after the reference information is scored as described above, the control privilege may be determined to be transferred to the first agent.

The control privilege manager 1130 may send a response message in response to the control privilege re-request message, to the first agent 1110 (operation 1145). The response message may contain a control privilege grant indication. If the response message contains a control privilege grant indication, the control privilege manager 1130 may send a privilege transfer notification message to the second agent 1120 (operation 1146). Upon reception of the privilege transfer notification message, the second agent 1120 may operate in the wait mode or passive mode (operation 1147). If the response message does not contain a control privilege grant indication, operations 1146 and 1147 may be skipped. Upon reception of the response message containing a control privilege grant indication, the first agent 1110 may operate in the active mode (operation 1148).

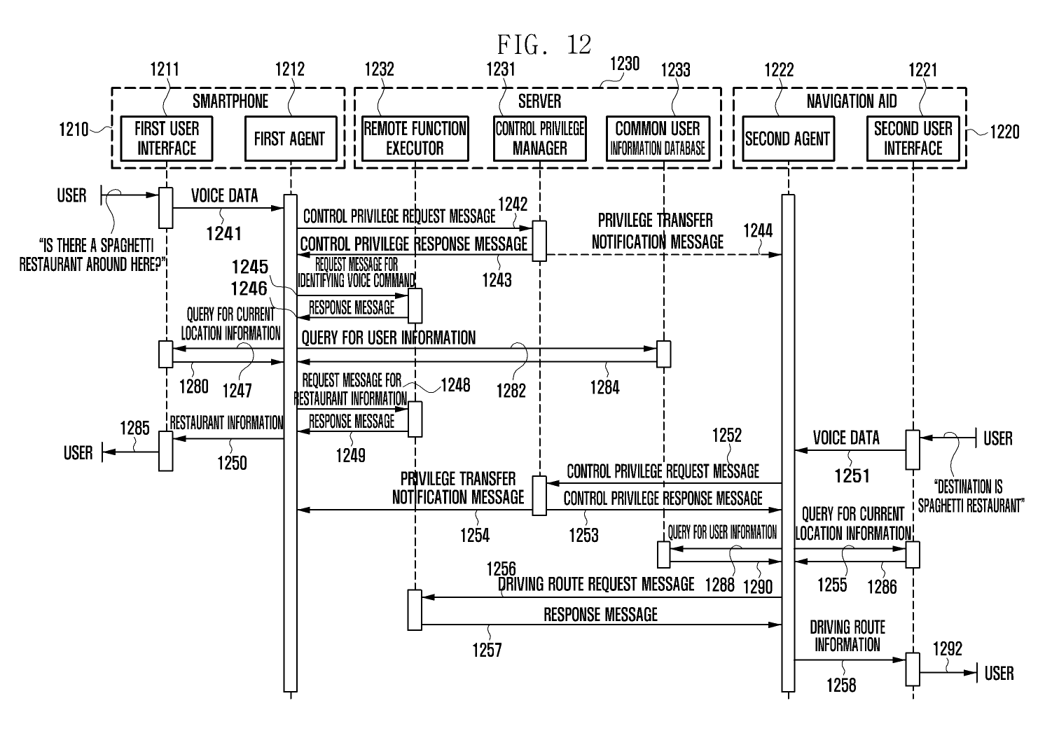

FIG. 12 is a sequence diagram for a detailed illustration of an agent service according to an exemplary embodiment. In FIG. 12, a smartphone 1210 may include a first user interface 1211 and a first agent 1212; a navigation system 1220 may include a second user interface 1221 and a second agent 1222; and a server 1230 may include a control privilege manager 1231, a remote function executor 1232 and a common user information database 1233. The smartphone 1210, the navigation system 1220 and the server 1230 may exchange messages through a mobile communication network or a local area network as described above.

The user at home may issue a voice query “Is there a spaghetti restaurant around here?” to the smartphone 1210. The first user interface 1211 may send voice data representing “Is there a spaghetti restaurant around here?” (e.g., voice command or voice query of the user) to the first agent 1212 (operation 1241). In response to the voice data, the first agent 1212 may send a control privilege request message to the control privilege manager 1231 (operation 1242). Upon reception of the control privilege request message, the control privilege manager 1231 may send a control privilege response message containing a control privilege grant indication to the first agent 1212 (operation 1243). If a control privilege is already granted to a different agent (e.g., second agent 1222), the control privilege manager 1231 may send a privilege transfer notification message to the second agent 1222 (operation 1244). Upon reception of the privilege transfer notification message, the second agent 1222 may operate in the wait mode.

Upon reception of the control privilege response message containing a control privilege grant indication, the first agent 1212 may operate in the active mode. The first agent 1212 with a control privilege may send a request message for identifying the voice command to the remote function executor 1232 (operation 1245). The remote function executor 1232 may recognize the voice command using an artificial intelligence engine as described above, and send a response message containing recognition results to the first agent 1212 (operation 1246). After reception of the response message, the first agent 1212 may obtain current location information from the first user interface 1211, for example, via a GPS receiver (operations 1247, 1280), and obtain user information (e.g., preferred franchise information) from the common user information database 1233 (operations 1282, 1284).

The first agent 1212 may send an information search request message (containing current location information and spaghetti franchise information) to the remote function executor 1232 (operation 1248). The remote function executor 1232 may obtain restaurant information related to the current location and spaghetti franchises (such as information on locations of spaghetti restaurants and prices) through a search engine, and send an information response message containing the obtained restaurant information to the first agent 1212 (operation 1249). The first agent 1212 may forward the restaurant information received from the remote function executor 1232 to the first user interface 1211 (operation 1250). The first user interface 1211 may display the restaurant information and output the same as sound (operation 1285).

After moving to a car, the user may issue a voice command “The destination is the spaghetti restaurant found before” to the navigation system 1220. The second user interface 1221 may send voice data representing “The destination is the spaghetti restaurant found before” to the second agent 1222 (operation 1251).

In response to the voice data, the second agent 1222 may send a control privilege request message to the control privilege manager 1231 (operation 1252). Upon reception of the control privilege request message, the control privilege manager 1231 sends a control privilege response message containing a control privilege grant indication to the second agent 1222 (operation 1253). The second agent 1222 with a control privilege operates in the active mode. The control privilege manager 1231 may send a privilege transfer notification message to the first agent 1212 (operation 1254). Upon reception of the privilege transfer notification message, the first agent 1212 may operate in the wait mode.

After obtaining a control privilege, the second agent 1222 may obtain current location information from the second user interface 1221, for example, via a GPS receiver (operations 1255, 1286), and obtain user information (e.g., information on spaghetti restaurants) from the common user information database 1233 (operations 1288, 1290). The second agent 1222 may send a driving route request message (containing current location information and spaghetti restaurant information) to the remote function executor 1232 (operation 1256). The remote function executor 1232 may obtain driving route information related to the current location and location information of the spaghetti restaurant) through a search engine, and send a response message containing the obtained driving route information to the second agent 1222 (operation 1257). The second agent 1222 may forward the driving route information received from the remote function executor 1232 to the second user interface 1221 (operation 1258). The second user interface 1221 may display the driving route information and may output the same as sound (operation 1292).

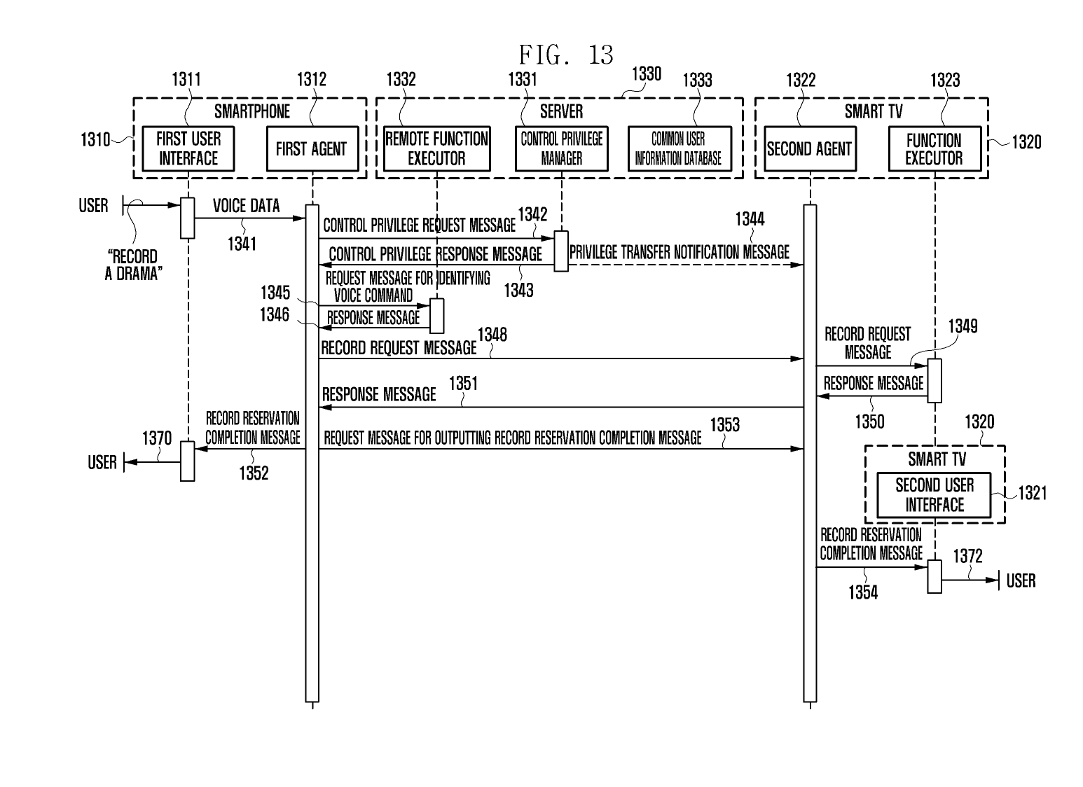

FIG. 13 is a sequence diagram for another detailed illustration of an agent service according to an exemplary embodiment.

In FIG. 13, a smartphone 1310 may include a first user interface 1311 and a first agent 1312; a smart TV 1320 may include a second user interface 1321, a second agent 1322 and a function executor 1323; and a server 1230 may include a control privilege manager 1331, a remote function executor 1332 and a common user information database 1333. The smartphone 1310, the smart TV 1320 and the server 1330 may exchange messages through a mobile communication network or a local area network as described above.

The user at home issues a voice command “record a drama” to the smartphone 1310. The first user interface 1311 may send voice data representing “record a drama” to the first agent 1312 (operation 1341).

In response to the voice data, the first agent 1312 may send a control privilege request message to the control privilege manager 1331 (operation 1342). Upon reception of the control privilege request message, the control privilege manager 1331 may send a control privilege response message containing a control privilege grant indication to the first agent 1312 (operation 1343). If a control privilege is already granted to a different agent (second agent 1322), the control privilege manager 1331 may send a privilege transfer notification message to the second agent 1322 (operation 1344). Upon reception of the privilege transfer notification message, the second agent 1322 may operate in the wait mode.

Upon reception of the control privilege response message containing a control privilege grant indication, the first agent 1312 may operate in the active mode. The first agent 1312 with a control privilege may send a request message for identifying the voice command to the remote function executor 1332 (operation 1345). The remote function executor 1332 may recognize the voice command using an artificial intelligence engine as described above, and sends a response message containing recognition results to the first agent 1312 (operation 1346). After reception of the response message, the first agent 1312 may obtain user information (e.g., information on dramas frequently viewed recently such as titles, broadcast schedules and leading actors) from the common user information database 1333, similarly to the described above with reference to FIG. 12.

The first agent 1312 may send a record request message (containing drama information) to the second agent 1322 (operation 1348). The second agent 1322 may forward the record request message to the function executor 1323 (operation 1349). The function executor 1323 may send a response message notifying record reservation to the second agent 1322 (operation 1350). The second agent 1322 may forward the response message to the first agent 1312 (operation 1351). The first agent 1312 may send a record reservation completion message to the first user interface 1311 (operation 1352). The first user interface 1311 may display the record reservation completion message and may output the same as sound (operation 1370). In addition, the first agent 1312 may remotely control the smart TV 1320 to display the record reservation completion message. Specifically, the first agent 1312 may send a request message for outputting the record reservation completion message to the second agent 1322 (operation 1353). The second agent 1322 may send the record reservation completion message to the second user interface 1321 (operation 1354). The second user interface 1321 may display the record reservation completion message and may output the same as sound (operation 1372).

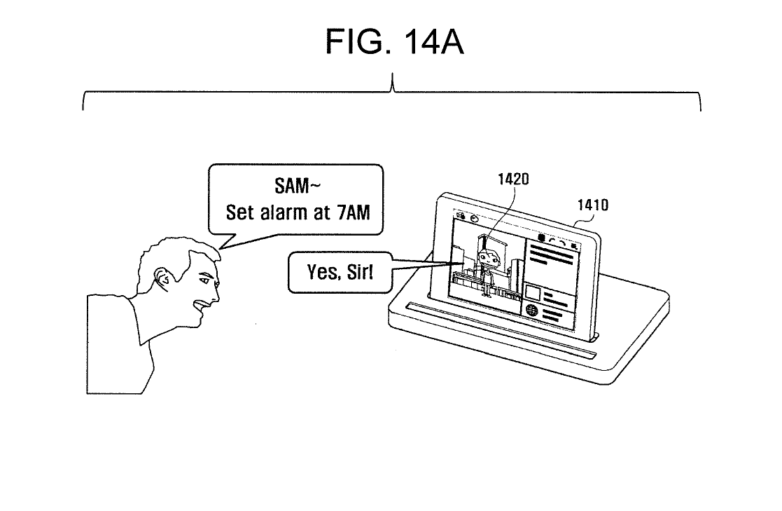

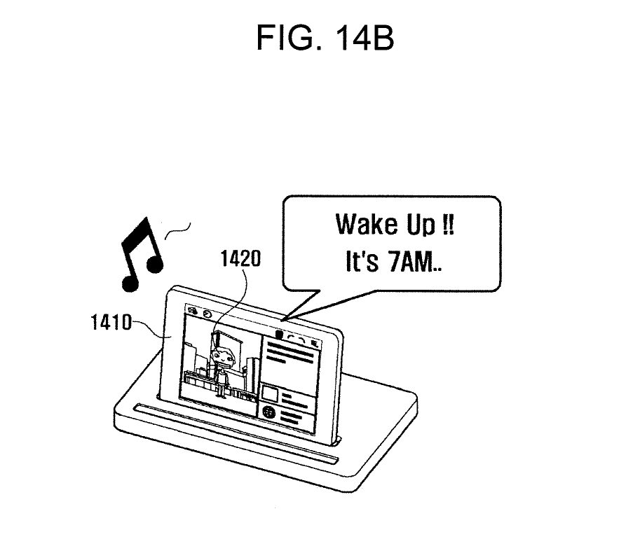

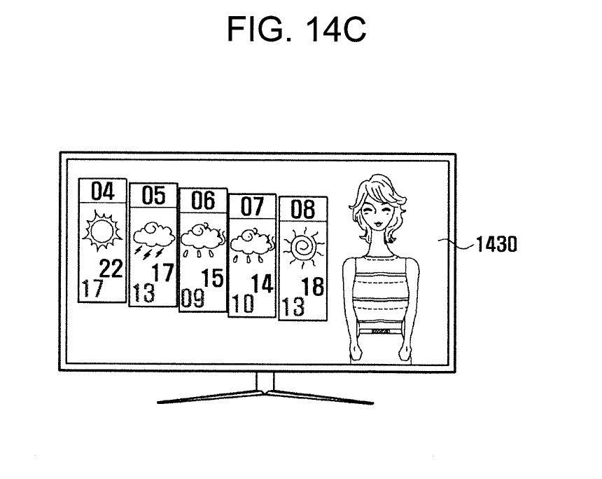

FIGS. 14 to 16 are brief illustrations of agent services according to an exemplary embodiment.

In FIGS. 14A, 14B, and 14C, the user may issue a voice command “Sam, set alarm for 7 AM” to an avatar 1420 displayed on a tablet PC 1410. The avatar 1420 corresponds to the agent of the tablet PC 1410. The avatar 1420 may recognize the voice command from the user using an artificial intelligence engine, and control the tablet PC 1410 to trigger the alarm at seven in the morning. The avatar 1420 may also remotely control a smart TV 1430 to tune to, for example, a user's favorite news channel at seven in the morning.

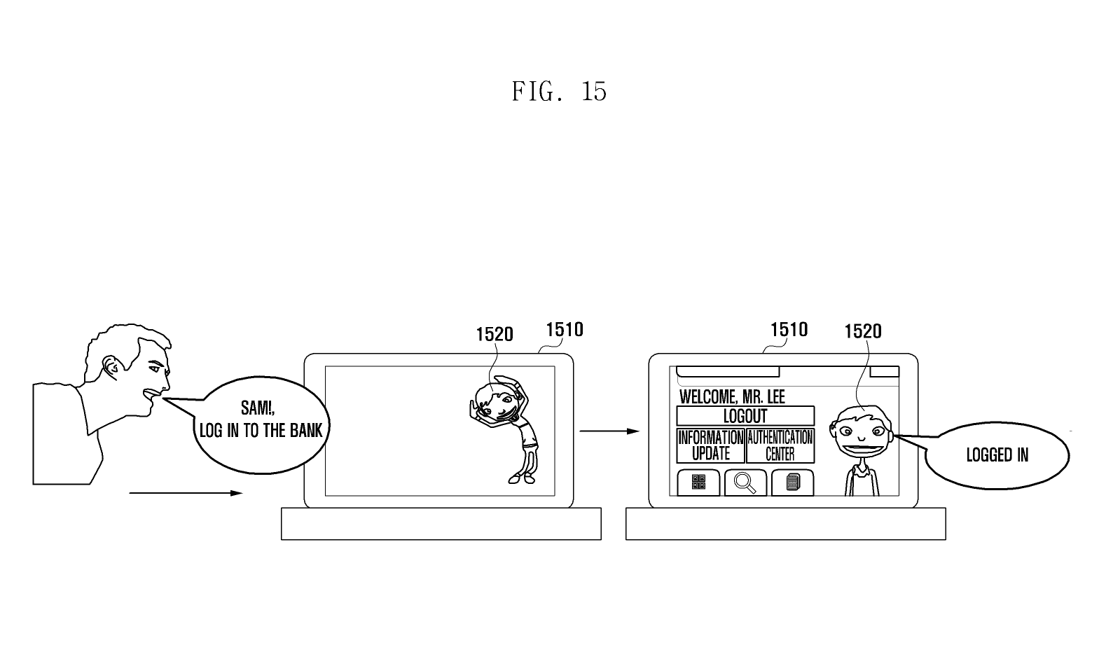

In FIG. 15, the user may issue a voice command “Sam, log in to the bank” to an avatar 1520 displayed on a tablet PC 1510. The avatar 1520 may recognize the voice command from the user using an artificial intelligence engine, connect to an Internet banking site frequently visited by the user, extract user information such as ID and password from the user information database, and enter the extracted user information to the Internet banking site to thereby automatically log in to the bank. The avatar 1520 may control the tablet PC 1510 to display a login page and audibly output “Automatically logged in”.

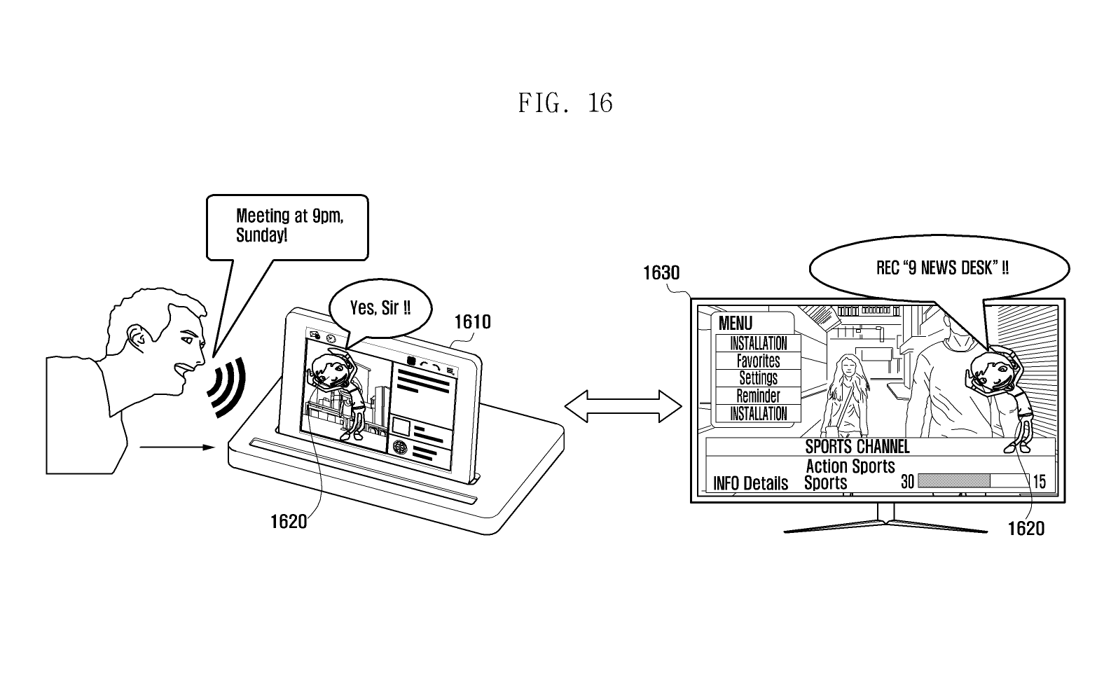

In FIG. 16, the user may issue a voice command “Meeting at 9 p.m. Sunday!” to an avatar 1620 displayed on a tablet PC 1610. The avatar 1620 may infer that the user will be out at 9 p.m. Sunday using an artificial intelligence engine, identify a broadcast program that is frequently viewed by the user at 9 p.m. Sunday using the user information database, and control a smart TV 1630 to record the identified broadcast program. The avatar 1620 may control the smart TV 1630 to display “Nine o'clock news will be recorded” and output the same as sound. For example, the agent of the tablet PC 1610 may remotely control the agent of the smart TV 1630 to audibly output “Nine o'clock news will be recorded.”

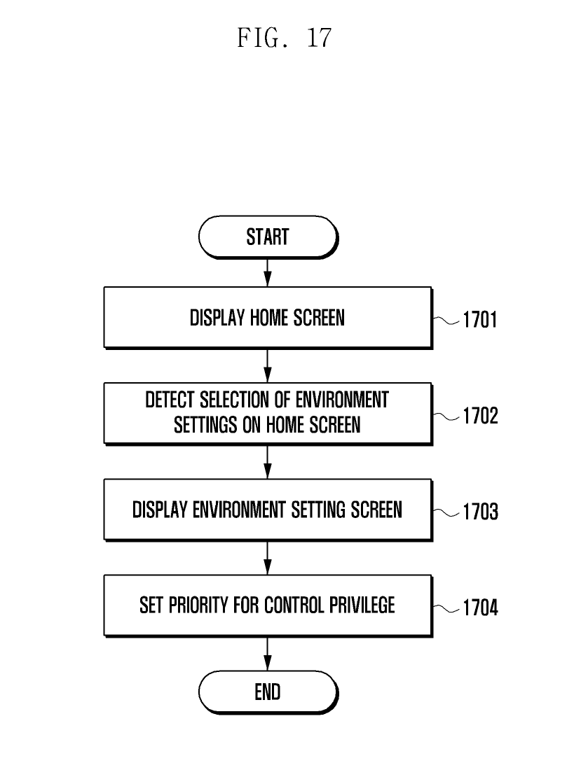

FIG. 17 is a flowchart of a process for configuring a control privilege according to an exemplary embodiment. Referring to FIGS. 1 and 17, the controller 150 of a terminal 100 may control the display 121 to display a home screen (operation 1701). The home screen may include an icon related to environment settings, and the user may select the icon. The controller 150 may detect selection of the environment setting icon on the home screen (operation 1702). The controller 150 may control the display 121 to display an environment setting screen (operation 1703). The controller 150 may set priority and management options for a control privilege (operation 1704). For example, the user may configure environment settings related particularly to the control privilege using the touch panel 111 through the environment setting screen. The environment settings may be stored in the storage 130. The control privilege setting information stored in the storage 130 may be utilized when negotiation between terminals is carried out to determine a terminal to manage the control privilege, and when the control privilege manager determines to grant a control privilege.

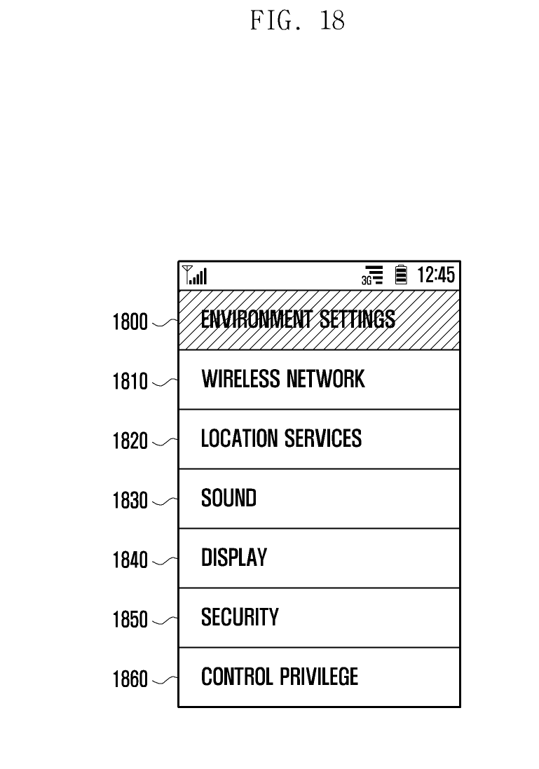

FIG. 18 illustrates an example environment setting screen for the terminal. The environment setting screen may contain diverse items according to performance and functions of the terminal 100. For example, referring to FIGS. 1 and 18, the display 121 may display an environment setting screen 1800 under control of the controller 150. The environment setting screen 1800 may contain various items according to performance and functions of the terminal 100. For instance, the environment setting screen 1800 may contain various items such as wireless network 1810, location service 1820, sound 1830, display 1840, security 1850 and control privilege 1860. The user may determine a terminal to manage the control privilege among terminals using the control privilege item 1860. For example, among terminals such as a smartphone, tablet PC and smart TV, the smartphone may manage the control privilege. The user may also determine the priority for the control privilege using the control privilege item 1860. For example, the smartphone, tablet PC and smart TV may have precedence in the order named. If each of the smartphone, tablet PC and smart TV detected voice data, the control privilege may be granted to the smartphone.

Another process for granting a control privilege is described as an exemplary embodiment with reference to Table 3.

TABLE 3

| | | Smartphone | | | | |
|---|---|---|---|---|---|---|
| | | (control | | | | Navigation |
| | | privilege) | Tablet PC | Laptop PC | TV | system |
| Network environment | | Home | Home | Home | Home | Vehicle |
| | | Vehicle | Vehicle | | | |
| Input interface | Microphone | ◯ | ◯ | ◯ | X | ◯ |
| | Camera | ◯ | ◯ | ◯ | X | X |
| | GUI | ◯ | ◯ | X | X | ◯ |
| | Pen | X | ◯ | X | X | X |
| | GPS | ◯ | ◯ | X | X | ◯ |
| | Remote control | X | X | X | ◯ | ◯ |
| Available | Broadcasting | ◯(DMB) | X | X | ◯(public) | X |
| function | Call | ◯ | X | X | X | X |
| | Message | ◯ | ◯ | X | X | X |
| | Information | ◯ | ◯ | ◯ | X | X |
| | search | | | | | |
| | Road guidance | X | ◯ | X | X | ◯ |
| Characteristics | Power (W) | 1600 | 4500 | 16500 | ∞ | 1600 |
| | Communication | WiFi | WiFi | WiFi | Wired | BT |
| | | 3G | BT | | | |
| | | BT | | | | |
| | | NFC | | | | |
| State | Remaining | −∞ | 80 | 40 | 60 | 20 |
| | computational | (none) | | | | |
| | capacity (%) | | | | | |
| | Communication | WiFi | WiFi | WiFi | WiFi | X |
| | state | | | | | |
| | Remaining | 65 | 30 | 85 | ∞ | ∞ |
| | battery power | | | | | |
| | (%) | | | | | |

Referring to Table 3, the user holding the smartphone with a hand while sitting on a sofa in a living room may issue a voice command to terminals. The smartphone, tablet PC and laptop PC belonging to the home network environment may detect user voice data. Upon detection of the voice data, the agents of the smartphone and tablet PC may send a control privilege request message to the control privilege manager of the smartphone. The control privilege request message may contain information regarding network environments, input interfaces, available functions, characteristics and states as illustrated in Table 3. The control privilege manager of the smartphone may calculate a difference between reception times of control privilege request messages. When the difference between reception times of control privilege request messages is within a preset threshold (e.g., 1 second), the control privilege manager may determine that the control privilege request messages have been generated by the same voice command. As the terminals having sent the request messages commonly belong to the home network environment, the control privilege manager may exclude the navigation system belonging to the vehicle network environment in candidate selection.

Because in this example a voice command is issued by the user, the control privilege manager may exclude a TV without a microphone in candidate selection. Because in this example the remaining computational capacity of the smartphone is zero, the control privilege manager may exclude the smartphone in candidate selection. With exclusion of the above terminals, the control privilege manager may select the tablet PC and laptop PC as candidates. The control privilege manager may represent evaluation factors of each candidate as numerical values. For example, the score for the power-related factor (X) may be computed by an equation “power*remaining battery power/a preset constant (e.g., 100)”. The score for the input interface related factor (Y) may be computed by an equation “(number of input interfaces*100)*remaining computational capacity/10”. The score for the available function related factor (Z) may be computed by an equation “(number of available functions*100)*remaining computational capacity/10”. The total score for a given candidate (T) may be computed by an equation “a*X+b*Y+c*Z”, where a, b and c are weights. When the weight for the input interface is relatively larger, a may be larger than b and c. Assuming that a, b and c are all 1, total scores (T) of the tablet PC and laptop PC may be computed as in Table 4.

TABLE 4

| | Tablet PC | Laptop PC |
|---|---|---|
| X | (4500 * 30/100) = 1350 | (16500 * 85/100) = 14025 |
| Y | (5 * 100 * 80/10) = 4000 | (2 * 100 * 40/10) = 800 |
| Z | (3 * 100 * 80/10) = 2400 | (1 * 100 * 40/10) = 400 |
| T (X + Y + Z) | 7750 | 15225 |

The control privilege manager may send a response message containing a control privilege grant indication to the laptop PC with a higher total score.

The methods, processes and/or operations of exemplary embodiments may be implemented as computer programs and may be stored in various computer-readable storage media. The computer-readable storage media may store program instructions, data files, data structures and combinations thereof. The program instructions may include instructions developed specifically for an exemplary embodiment and existing general-purpose instructions. The computer-readable storage media may include magnetic media such as a hard disk and floppy disk, optical media such as a CD-ROM and DVD, magneto-optical media such as a floptical disk, and memory devices such as a ROM and RAM. The program instructions may include machine codes produced by compilers and high-level language codes executable through interpreters. Each hardware device may be replaced with one or more software modules to perform operations according to an exemplary embodiment, and vice versa.

The described-above exemplary embodiments and advantages are merely exemplary and are not to be construed as limiting. The present teaching can be readily applied to other types of apparatuses. The description of exemplary embodiments is intended to be illustrative, and not to limit the scope of the claims, and many alternatives, modifications, and variations will be apparent to those skilled in the art.

What is claimed is:

1. A method comprising:
sending a control privilege request message to a control privilege manager;
receiving, by an agent, a control privilege response message corresponding to the control privilege request message; and
transitioning from a passive mode during which the agent is remotely controlled by an external device to an active mode during which the agent remotely controls an external device.

2. The method of claim 1, wherein the transitioning from the passive mode to the active mode is performed when a control privilege grant indication is present in the control privilege response message.

3. The method of claim 1, further comprising:
receiving, by the agent included in a terminal, user input information.

4. The method of claim 3, wherein the user input information is one of voice data, touch data, and image data.

5. The method of claim 3, wherein, when the user input information is the voice data, the sending the control privilege request message is performed after a user of the voice data is recognized.

6. The method of claim 1, wherein the sending the control privilege request message comprises:
transmitting the control privilege request message containing reference information comprising at least one of terminal characteristic information, terminal state information, user input information, requested function information indicating a user requested function, and user identification (ID).

7. The method of claim 1, wherein the agent operates in the active mode and the method further comprises:
detecting, by the agent, a privilege transfer event;
sending, upon detection of the privilege transfer event, a privilege transfer request message to the control privilege manager; and
transitioning, by the agent, from the active mode to a wait mode, during which the agent is remotely controlled by the external device and is permitted to re-request the control privilege.

8. The method of claim 1, further comprising:
entering, by the agent, the passive mode during which the agent executes a function of a terminal under remote control of the external device or a wait mode during which the agent is remotely controlled by the external device and is permitted to re-request the control privilege, when a control privilege grant indication is absent in the control privilege response message.

9. The method of claim 8, wherein the control privilege response message comprises a candidate indication for the control privilege and the method further comprises:
entering, by the agent, the wait mode;
detecting, by the agent operating in the wait mode, a privilege re-request event; and
sending, upon detection of the privilege re-request event, a control privilege re-request message to the control privilege manager.

10. A method comprising:
receiving request messages for a control privilege enabling remote control of an external device from at least two agents included in a terminal and in the external device;
determining to grant the control privilege to at least one of the at least two agents based on reference information contained in the request messages; and
sending a response message containing a control privilege grant indication to the agent determined to receive the control privilege.

11. The method of claim 10, wherein the determining to grant the control privilege comprises:
selecting one or more candidates from the at least two agents based on user input information contained in the reference information; and
determining to grant the control privilege to one of the one or more candidates.

12. The method of claim 11, wherein the selecting comprises selecting one or more agents, which received voice data as user input information, as the one or more candidates, respectively.

13. The method of claim 11, wherein the determining to grant the control privilege comprises granting the control privilege to the candidate with a highest signal-to-noise ratio (SNR) for the voice data, if more than one candidate is selected.

14. The method of claim 11, wherein multiple candidates are selected and the determining to grant the control privilege comprises:
representing reference information of each of the candidates as a numerical score; and
granting the control privilege to the candidate with the highest score.

15. A terminal comprising:
a wireless communicator configured to communicate with an external device; and
a controller configured to control the wireless communicator,
wherein the controller is configured to control the wireless communicator to send a control privilege request message and to receive a control privilege response message corresponding to the control privilege request message, and transitions, from a passive mode during which the controller is remotely controlled by an external device to an active mode during which the controller remotely controls the external device when a control privilege grant indication is present in the control privilege response message.

16. The terminal of claim 15, further comprising a user interface interacting with a user,
wherein the controller is configured to control the user interface.

17. The terminal of claim 16, wherein the controller is configured to control, upon reception of user input information through the user interface, the wireless communicator to send the control privilege request message.

18. The terminal of claim 15, wherein the controller controls, upon detection of a privilege transfer event, the wireless communicator to send a privilege transfer request message, and
transitions from the active mode to a wait mode during which the controller is remotely controlled by the external device and is permitted to re-request the control privilege.

19. The terminal of claim 15, wherein the controller is configured to enter the passive mode during which the controller executes a function of the terminal under remote control of the external device or a wait mode during which the controller is remotely controlled by the external device and is permitted to re-request the control privilege, when a control privilege grant indication is absent in the control privilege response message.

20. The terminal of claim 15, wherein the control privilege response message comprises a candidate indication for the control privilege,
the controller is configured to enter the wait mode, and
the controller is configured to control, upon detection of a privilege re-request event, the wireless communicator to send a control privilege re-request message.

21. A terminal comprising:
a wireless communicator configured to receive request messages for a control privilege for enabling remote control of other devices, from external devices; and
a controller configured to control the wireless communicator,
wherein the controller is configured to determine to grant a control privilege to one of the external devices based on reference information contained in the request messages, and controls the wireless communicator to send a response message containing a control privilege grant indication to the external device determined to receive the control privilege.

22. The terminal of claim 21, wherein the controller selects one or more candidates from the external devices based on user input information contained in the reference information and determines to grant the control privilege to one of the candidates.

23. The terminal of claim 22, wherein multiple candidates are selected,
the controller represents reference information of each of the candidates as a numerical score and determines to grant the control privilege to the candidate with a highest score.

24. A non-transitory storage medium storing program instructions which, when executed a processor of a terminal supporting wireless communication, cause the processor to execute a method comprising:
sending a control privilege request message to a control privilege manager;
receiving, by an agent, a control privilege response message corresponding to the control privilege request message; and
transitioning from a passive mode during which the agent is remotely controlled by an external device to an active mode during which the agent remotely controls an external device.
